(19) United States
(12) Patent Application Publication
(10) Pub. No.: US 2023/0034773 A1
(43) Pub. Date: Feb. 2, 2023

(54) ELECTRONIC HEADSET FOR TEST OR EXAM ADMINISTRATION

(71) Applicant: Lenovo (Singapore) Pte. Ltd., Singapore (SG)

(72) Inventors: Song Wang, Cary, NC (US); Jian Li, Durham, NC (US); Zhenyu Yang, Morrisville, NC (US); Mengnan Wang, Morrisville, NC (US)

(21) Appl. No.: 17/387,086

(22) Filed: Jul. 28, 2021

(51) Int. Cl. G09B 7/02; G06F 1/16; G06F 3/01; G06K 9/00; G06F 3/14

(52) U.S. Cl. CPC G09B 7/02; G06F 1/163; G06F 3/013; G06K 9/00671; G06F 3/14

(57) ABSTRACT

In one aspect, a headset may include at least one processor, a display accessible to the at least one processor, a camera accessible to the processor, and storage accessible to the at least one processor. The storage may include instructions executable by the at least one processor to receive one or more images from the camera. Based on the one or more images, the instructions may then be executable to identify a predetermined object within a user's field of view and/or identify a location of the display at which or through which the user is looking. Based on the identification(s), the instructions may then be executable to take at least one action related to administration of a test or examination.

### FIELD

The disclosure below relates to technically inventive, non-routine solutions that are necessarily rooted in computer technology and that produce concrete technical improvements. In particular, the disclosure below relates to techniques for using electronic headsets to administer tests and examinations.

### BACKGROUND

As recognized herein, cheating on tests and exams is a prevalent problem that has only been exacerbated by advancements in technology. This is particularly true in electronic remote-learning environments, and also in in-person testing environments where the test-takers heavily outnumber the proctors and make adequate mass-monitoring difficult or impossible. Indeed, many times the test-takers use electronic devices to take the test, but the proctors might not have exclusive control over all materials the test-takers might be able to access via their electronic devices. There are currently no adequate solutions to the foregoing computer-related, technological problem.

### SUMMARY

Accordingly, in one aspect a headset includes at least one processor, a display accessible to the at least one processor, a camera accessible to the at least one processor, and storage accessible to the at least one processor. The storage includes instructions executable by the at least one processor to receive one or more images from the camera. The instructions are then executable to, based on the one or more images, identify a predetermined object within a user's field of view and/or a location of the display at which or through which the user is looking. Based on the identification, the instructions are then executable to take at least one action related to administration of a test or examination.

Thus, in one example implementation the instructions may be executable to execute eye tracking using the one or more images and, based on the eye tracking, identify the location of the display at which or through which a user is looking. The instructions may then be executable to, based on the identification of the location of the display at which or through which the user is looking, present content on the display at the location to at least partially obstruct the user's view of the real world via the display. The content may include an electronic page of the test or examination and/or a warning message related to cheating on the test or examination.

Also in one example implementation, the instructions may be executable to execute object recognition using the one or more images and, based on the object recognition, identify the predetermined object within the user's field of view. The instructions may then be executable to, based on the identification, present a warning message on the display. The warning message may indicate that the predetermined object should not be present during administration of the test or examination. Additionally, based on a determination that the predetermined object exists within the user's field of view for at least a threshold non-zero amount of time, in some examples the instructions may then be executable to transmit a notification to a device associated with a proctor, with the notification indicating that the predetermined object has been identified.

Additionally, or alternatively, in one example implementation the instructions may be executable to execute object recognition using the one or more images and, based on the object recognition, identify the predetermined object within the user's field of view. Based on the identification, the instructions may then be executable to present content on the display to at least partially obstruct the user's view of the predetermined object via the display. The content may include an electronic page of the test or examination itself, and/or a warning message related to cheating on the test or examination. The predetermined object may include another electronic device besides the headset, a book, a person within a threshold distance to the headset, a person facing the headset, a person speaking, and/or a person gesturing.

Still further, in some examples the instructions may be executable to execute eye tracking using the one or more images and, based on the eye tracking, identify the user as looking in a particular direction toward the location for at least a threshold non-zero amount of time. Based on the identification of the user as looking in the particular direction for at least the threshold non-zero amount of time, the instructions may then be executable to present content on the display at the location to at least partially obstruct the user's view of the real world via the display in the particular direction, and/or to present a warning message related to cheating on the test or examination.

Additionally, in some examples the instructions may be executable to execute object recognition using the one or more images and, based on the object recognition, identify the predetermined object within the user's field of view. Based on the identification, the instructions may then be executable to transmit a notification to a device associated with a proctor. The notification may indicate that the predetermined object has been identified. According to this example, the predetermined object may include a non-headset electronic device being used by a person other than the user, and the notification may indicate the person.

In another aspect, a method includes receiving one or more images from a camera on a headset. Based on the one or more images, the method includes identifying a predetermined object within a user's field of view and/or identifying a particular location of a display of the headset. The particular location is in a direction of the user's current line of sight. Based on the identification, the method then includes taking at least one action related to administration of a test or examination.

Thus, in one example the method may include executing eye tracking using the one or more images and, based on the eye tracking, identifying the particular location of the display. Based on the identification of the particular location of the display, the method may then include presenting content on the display at the particular location to at least partially obstruct the user's view of the real world via the display. The content may include an electronic page of the test or examination and/or a warning message related to the test or examination.

Also in one example, the camera may be oriented away from the headset to generate images of the user's field of view. In this example, the method may include executing object recognition using the one or more images and, based on the object recognition, identifying the predetermined object within the user's field of view. Based on the identification, the method may then include presenting a warning message on the display. The warning message may indicate that the predetermined object should not be present during administration of the test or examination. The predetermined object may include another electronic device besides the headset, a book, a person within a threshold distance to the headset, a person facing the headset, a person speaking, and/or a person gesturing. Further, in some cases the method may include, based on determining that the predetermined object exists within the user's field of view for at least a threshold non-zero amount of time, transmitting a notification to a device associated with a proctor. The notification may indicate that the predetermined object has been identified.

Additionally, if desired the method may include executing object recognition using the one or more images and, based on the object recognition, identifying the predetermined object within the user's field of view. Here the predetermined object may include a non-headset electronic device being used by a person other than the user. Based on the identification, the method may then include transmitting a notification to a device associated with a proctor, where the notification may indicate the person.

In still another aspect, at least one computer readable storage medium (CRSM) that is not a transitory signal includes instructions executable by at least one processor to receive one or more images from a camera on a headset. Based on the one or more images, the instructions are executable to identify a predetermined object within a user's field of view and/or a particular location of a display of the headset. The particular location is in a direction of the user's current line of sight. Based on the identification, the instructions are then executable to take at least one action related to administration of a test or examination.

Thus, in some examples the at least one action may include presenting pages of the test or examination in a first sequence that is different from a second sequence, where the second sequence but not the first sequence was being used prior to the identification in order to present pages of the test or examination at the headset.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a top plan view of an example headset consistent with present principles;

FIGS. 4 and 7 show example graphical user interfaces (GUIs) that may be presented to a taker of a test or exam consistent with present principles;

FIG. 5 shows an example GUI that may be presented to a proctor consistent with present principles;

FIG. 6 shows example logic in example flow chart format that may be executed by a headset or other system consistent with present principles; and

FIG. 8 shows an example GUI that may be presented for configuring one or more settings of a system to operate consistent with present principles.

### DETAILED DESCRIPTION

Among other things, the detailed description below relates to use of augmented reality (AR) and associated headsets to help prevent cheating loopholes during in-person and remote testing. The disclosure below thus discusses the use of AR glasses and other types of headsets to implement anti-cheating measures, whether all test-takers are present at the same testing center, all test-takers are remotely located from each other, or some are present at the same testing center and some are remotely-located.

Specifically, device sensor information from the AR headset may be used to place a test overlay right in front of user's eyes. By having the test contents placed in front of the user in the direction of the user's gaze (and/or similarly presenting warning messages), this can create a deterrence from cheating since these overlays may make it harder to look at potential cheat materials beyond the headset such as books, other devices containing answers to the test, etc. since those external items will be at least somewhat obscured.

As also described herein, AR glasses may be equipped with outward facing cameras for facial/object recognition. Then if suspicious objects such as a smart watch, a mobile phone, a calculator, a book, etc. are detected, a warning message can be displayed to alert the end user that such devices/equipment/objects are not allowed during test. Furthermore, persistent recognition of unwanted objects during tests may trigger existing live proctors to monitor the student in real time. Thus, the use and assignment of proctors may be made much more efficient and effective.

Still further, note that in examples where several test pages are displayed/positioned at various view locations at one time via the AR glasses, object recognition of unwanted objects by the AR glasses may be used for detecting user intention of cheating and possibly presenting a warning message even if, for example, it is not desired to always place the test content directly in front of/in the direction of the user's gaze.

Additionally, if desired and as also described herein, AR glasses may be used for peer monitoring during in-person testing without necessarily raising user awareness during the in-person testing. For instance, many AR glasses wearers will at one point or another during a test look in the direction of other test-takers consciously or unconsciously, so during that time the image/video stream obtained from their outfacing cameras can be used to analyze nearby peer behavior to detect whether secondary devices such as earbuds, a smart watch, or mobile devices are being used by the nearby test-takers (where those objects might not be allowed during the test itself). Facial recognition may be used to identify the nearby test-taker, and a proctor alert can be triggered subsequently.

Moreover, if suspicious behavior is detected during a test, such as audio/conversation being detected and/or unwanted objects/applications being detected, the AR glasses/testing system can also randomize the pages of the tests so each tester will be shown different contents during a given moment or segment of the testing session. Thus, different tests or test versions may be presented, or different pages of the same test/version may be presented during that time for concurrent presentation to different test-takers.

Furthermore, though the principles described herein might be described in reference to AR glasses, note that present principles may also apply to virtual reality (VR) headsets and other types of headsets, including those with outward facing external cameras.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM, or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

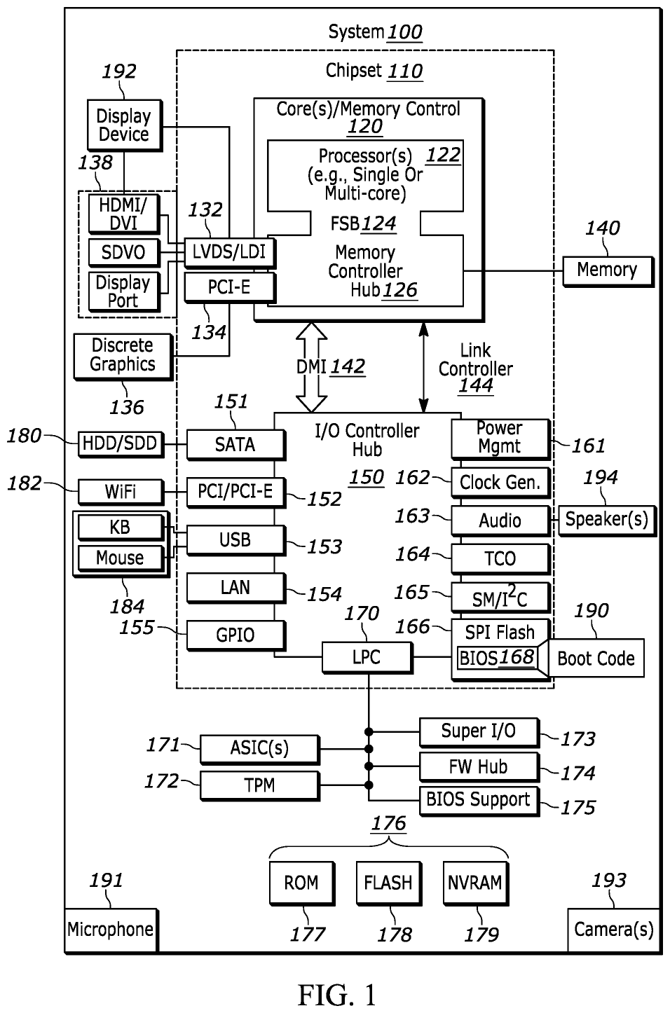

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may include an audio receiver/microphone 191 that provides input from the microphone to the processor 122 based on audio that is detected, such as via a user providing audible input to the microphone, or an oral conversation detected between two test-takers or a test-taker and a non-test-taker. The system 100 may also include a camera 193 that gathers one or more images and provides the images and related input to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

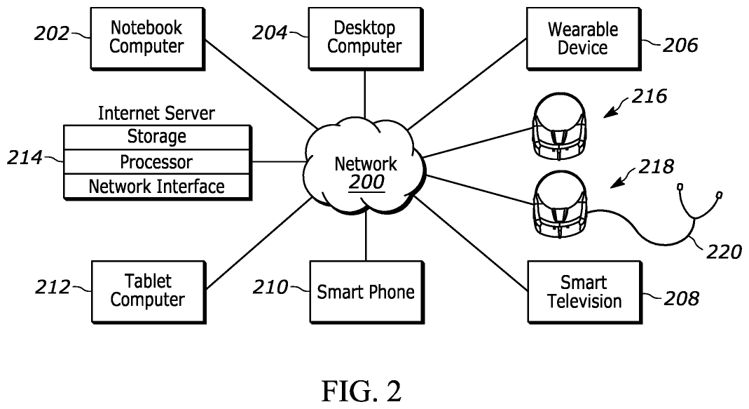

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, headsets 216 and 218, headphones 220, and a server 214 such as an Internet server that may provide cloud storage accessible to the devices 202-212, 216, 218, 220. Note that the devices shown in FIG. 2 may all be remotely-located from each other by tens of miles or more, and/or some of them may be commonly-located at a physical test center at which a test is being administered consistent with present principles. But it is to be nonetheless understood that the devices 202-220 are configured to communicate with each other over the network 200 to undertake present principles.

Describing the headphones 220 in more detail, they may be, for example, ear buds style headphones as shown. However, they may also be established by ear cup headphones and other types of headphones.

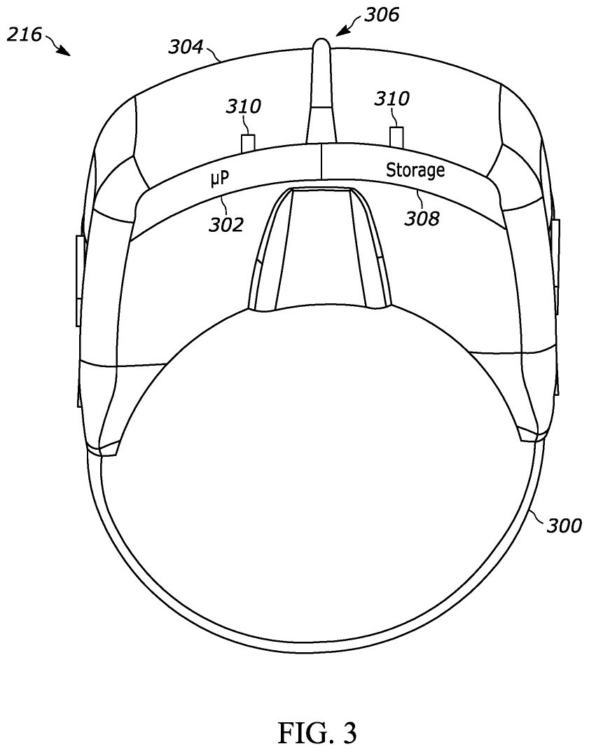

Now describing FIG. 3, it shows a top plan view of a headset such as the headset 216 consistent with present principles. The headset 216 may include a housing 300, at least one processor 302 in the housing, and a transparent “heads up” display 306 accessible to the at least one processor 302 and coupled to the housing 300. The display 306 may for example have discrete left and right eye pieces as shown for presentation using augmented reality software of stereoscopic and/or augmented reality images/objects, such as presentation of visual test or exam pages content consistent with present principles.

The headset 216 may also include one or more forward-facing cameras 306. As shown, the camera 306 may be mounted on a bridge portion of the display 304 above where the user's nose would be so that it may have an outward-facing field of view similar to that of a user himself or herself while wearing the headset 216. The camera 306 may be used for object and facial recognition as described herein. However, further note that the camera(s) 306 may be located at other headset locations as well.

Further, note that in some examples the camera(s) 306 may also be used for computer vision, image registration, spatial mapping, and/or simultaneous localization and mapping (SLAM) for augmented reality (AR) processing and presentation of AR content in conjunction with the headset's location in the real world itself. Further note that in some examples, inward-facing cameras 310 may also be mounted within the headset 216 and oriented to image the user's eyes for eye tracking while the user wears the headset 216 consistent with present principles.

Additionally, the headset 316 may include storage 308 accessible to the processor 302 and coupled to the housing 300, as well as still other components not shown for simplicity such as a network interface for communicating over a network such as the Internet, a microphone for detecting audio, and a battery for powering components of the headset 216 such as the camera(s) 306. Additionally, note that while the headset 216 is illustrated as a head-circumscribing augmented reality (AR) headset, it may also be established by computerized smart glasses or another type of headset.

For example, the headset may be established by a virtual reality (VR) headset that may not have a transparent display but may still be able to present virtual AR objects/content on its display along with a real-world, real-time camera feed of an environment imaged by the front-facing camera(s) 306 to provide an AR experience to the user as part of taking a test or examination.

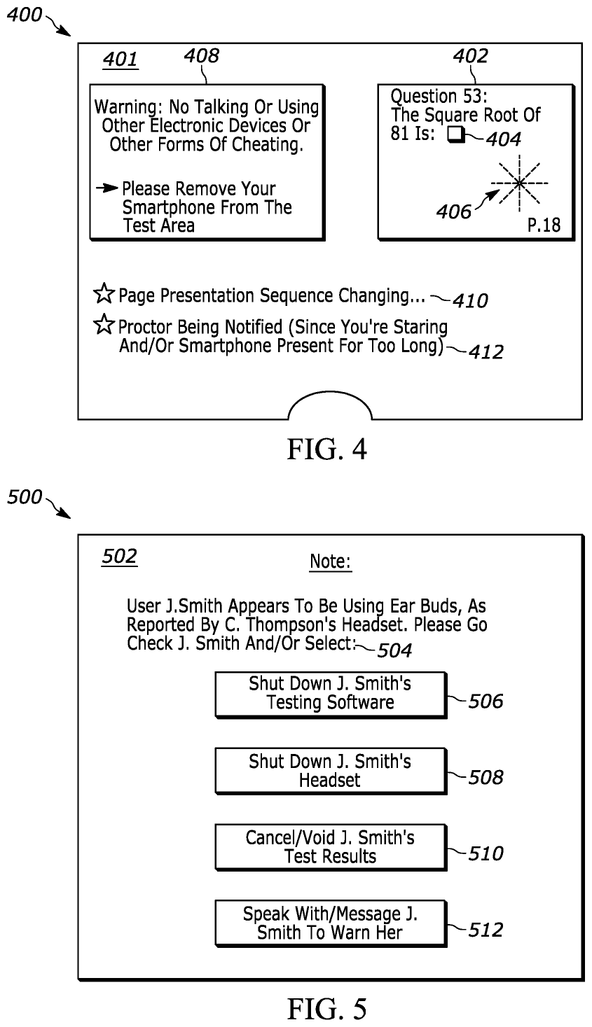

Referring now to FIG. 4, suppose a user is using a headset such as the headset 216 to take a test or examination. As part of the test or exam, a page 402 of the test is digitally/virtually presented on a display 400 of the headset as a graphical user interface (GUI) 401. As shown, the page 402 is “page 18” of the test itself and presents a math question to the user along with an answer entry box 404 at which the user may enter an answer to the question.

Note the positioning of the page 402. Specifically, the page 402 is not presented in the visual center of the display 400. Instead, the page 402 is presented off-center to include a display location 406 at which or through which the user is determined to be looking (e.g., determined based on eye tracking using one or more of the inward-facing headset cameras) to at least partially obstruct or obscure the user's view of the real world via the display in the direction of the location 406. This may be done to help block any surreptitiously hidden notes or other cheating materials in the real world that the user might attempt to look at through the location 406. Note that the asterisk-type indicator shown at the location 406 per FIG. 4 may or may not actually be presented as visual content on the display 400. If presented, this can give the user an indication of why the page 402 is presented where it is presented on the display 400.

Additionally, suppose that one or more conditions have been met for triggering presentation of a warning message 408. One of the conditions might be, for example, the user's headset identifying another electronic device (non-headset) such as a smart phone within a threshold distance to the headset while the user is taking the test. The threshold distance may be established by the test's creator and/or a test proctor and might be, for example, twenty feet. This condition/trigger may be identified using object recognition to recognize the other electronic device and using computer vision and a camera imaging the user's field of view (e.g., the camera 306 described above) to determine whether the other device is within the threshold distance.

However, further note that in some examples the condition/trigger may only be satisfied if, for example, the other electronic device is not just identified but is specifically identified as currently producing audio and/or having its display illuminated. To this end, a microphone array and beamforming may be used to identify any audio as coming from a direction of the other device, and object recognition may be used to identify whether the display is illuminated. In this way, the user might be able to keep their cell phone handy for emergencies while their headset still ensures that no external content is being presented to the user via the cell phone in order to cheat on the test. Notwithstanding, further note that for highly-sensitive exams, the trigger might be met when any electronic device is recognized within the field of view of the headset's outward-facing camera (e.g., regardless of whether that device is presenting audio or visual content and/or regardless of distance to the headset itself).

As another example of a condition for triggering presentation of the warning message 408, the headset may analyze input from its local microphone using natural language processing (NLP), and even natural language understanding (NLU) specifically, in order to analyze audio that is detected by the microphone, whether that audio be from a real-life person proximate to the user or audio from another electronic device like the user's smart phone. The headset may thus use NLP to determine whether any words detected from the audio relate to topics or keywords of the test material itself, which may indicate cheating in scenarios where people are supposed to take the test individually without conversing with others. However, also note that in other examples the detection of any words regardless of topic or keyword may be the trigger as an enhanced anti-cheating measure.

As may be appreciated from FIG. 4, the warning message 408 itself may indicate that no talking is allowed during the test and that using other electronic devices is also prohibited, as are other forms of cheating. The message 408 might also include instructions as shown for the user to remove an identified non-headset electronic device (a smart phone in this example) from the test area (e.g., place it outside of the threshold distance from the headset).

Still further, note that in addition to or in lieu of presenting the visual message 408, a text to speech engine may be used to convert the text of the message 408 to audio. The audio may then be presented to the user using one or more built-in speakers on the headset and/or using other speakers in the user's environment.

As also shown in FIG. 4, in some examples the display 400 may present still other visual content during administration of the test or exam. For example, a notification 410 may be presented to indicate that, based on the headset detecting one or more triggers as discussed herein, the page presentation sequence for the various pages of the test being administered is being changed to help further prevent cheating. This may be particularly helpful where a dishonest test taker might know the test answer sequence in advance, have the answers relayed in a particular sequence during the test via another electronic device, or be able to look at the test answers of another person next to the user. Thus, the page sequence may be randomized subsequent to detection of the trigger, or another predetermined sequence may be adopted if one has been configured by the test creator or a proctor. Additionally, or alternatively, based on detection of the trigger, a different test altogether may be provided if more than one version is available.

A notification 412 might also be presented on the display 400. As shown, the notification 412 may indicate that a proctor has been notified about the one or more triggers detected by the user's headset. Specifically, the notification 412 in this example indicates that the user's smart phone being present is one trigger, and also indicates that the user staring at or through a particular location of the display 400 for more than a threshold time is another trigger since staring beyond the display 400 rather than reading through the test's pages from left to right, up to down might also be indicative of cheating (e.g., viewing cheat information in the distance beyond the headset display). This threshold time may be five seconds, for example, to avoid false positives.

Now describing FIG. 5, it shows an example GUI 502 that may be presented on the display 500 of a device associated with a human proctor that is supervising one or more people taking a test consistent with present principles. The proctor's device may be a headset or other type of electronic device such as a laptop computer. The GUI 502 may be presented responsive to the proctor being electronically notified of one or more triggers identified by a user's headset as being potentially indicative of cheating on the test or exam. The trigger may be one of the ones already discussed above or may be something else as in the present example.

Specifically, here the trigger is a forward-facing camera for one user's headset identifying another test-taking person within the camera's field of view as using a predetermined non-headset electronic device that has been flagged as banned during test taking (e.g., by the proctor). The non-headset electronic device might be a smart phone, laptop, or tablet computer. Or as in the present example, the banned electronic device is or includes wireless ear buds for presenting audio to the other person's ears.

However, further note that the banned predetermined object might be something other than a certain type of electronic device, whether identified as being used by the user of the headset doing the detecting or used by the other test-taker within the field of view of the user's outward-facing headset camera. For example, the predetermined object might be a tangible book or other printed publication with tangible paper pages, a person within a threshold distance to user's headset or other test-taker's own headset, a person facing either one of the headsets (e.g., indicating the person is addressing the respective test-taker), another person speaking generally or to the other test-taker or user specifically, or a person gesturing with hands and arms toward the user or other test-taker. To this end, object recognition, facial recognition, and gesture recognition may all be executed by the user's headset to identify these predetermined objects.

Additionally, in some examples the predetermined object may be another software application that is being executed and visually presented at another device (e.g., an Internet browser with a Wikipedia page, or a text messaging application, being presented on a smart phone display). This too may be identified by the user's headset based on a comparison of a camera image showing the application to reference application images to determine whether the image shows an extraneous application window, or an application window related to the test itself. The extraneous application may also be identified as simply having nothing to do with the testing software based on the known application windows that are to be presented during testing.

In any case, as shown in FIG. 5, in this example the headset of a test-taker named “C. Thompson” has identified another test-taker “J. Smith” as using electronic ear buds while taking the test in a common area. Thus, the GUI 502 includes a notification 504 indicating as much. As also shown, the notification 504 also instructs the proctor to go over to the location where J. Smith is taking the test in order to verify and possibly take action.

However, if desired the proctor may take action directly at his/her own device by selecting one of the selectors 506-512 using touch input, cursor input, or other input. One of the selectors 506-512 may thus be selected to transmit a command to the test-taking software being executed at J. Smith's headset to act in conformance with the command, and/or to transmit a command to a server or other device facilitating testing to act in conformance with the command.

Selector 506 may thus be selected to provide a command to shut down or close J. Smith's testing software as executing at J. Smith's headset. Selector 508 may be selected to provide a command to shut down or power off J. Smith's headset itself (or whatever device J. Smith might be using to take the test). Selector 510 may be selected provide a command to the aforementioned server to cancel, void, and/or delete J. Smith's test results or test answers, either upon selection of the selector 510 or upon J. Smith actually completing the exam. Selector 512 may be selected to open a channel of communication for voice and/or text chat with J. Smith using J. Smith's headset display or headset speakers for the proctor to remotely warn J. Smith that the banned ear buds should be taken out of her ears and no longer used during testing.

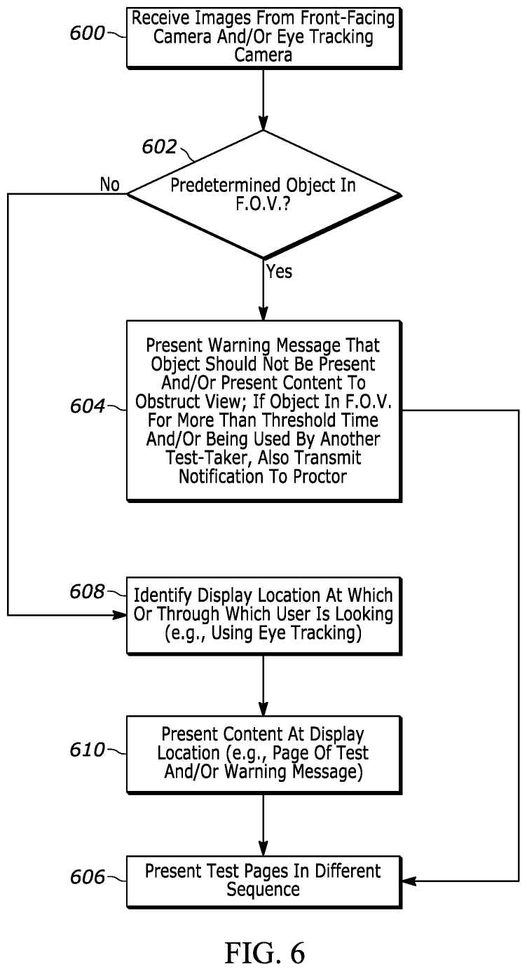

Referring now to FIG. 6, it shows example logic that may be executed by a device such as the system 100 and/or a test-taker's headset consistent with present principles. Beginning at block 600, the device may receive images from one or more of its cameras, such as an outward-facing camera imaging the user's own outward field of view and/or one or more inward-facing cameras imaging the user's eyes for eye tracking. From block 600 the logic may then proceed to decision diamond 602.

At diamond 602 the device may execute object recognition and/or facial recognition to identify any predetermined inanimate objects and/or people shown in images from the outward-facing camera that have been flagged for monitoring (e.g., by a system administrator or test creator). Responsive to an affirmative determination that one or more predetermined objects have been identified, the logic may proceed to block 604 where the device may present a warning message at the user's headset that the recognized object should not be present during the test.

Additionally, or alternatively, at block 604 the device may present content at one or more display locations to obstruct the user's view of the object as discussed above. To do so, the device may use the images from the outward-facing camera to deduce a bearing from the user's eyes to the object and then infer a display location intersecting the bearing. The content may then be presented at that display location to obstruct or obscure the user's view of the predetermined object.

Also at block 604, in some examples the device may also transmit a notification to a test proctor, such as the notification described above in reference to FIG. 5, if the device determines based on the images that the predetermined object is within the field of view for more than a threshold time (e.g., more than five seconds to avoid false positives) and/or if the device determines the object is being used by another test-taker (e.g., per the J. Smith example above). From block 604 the logic may then proceed to block 606, which will be described shortly.

However, referring back to decision diamond 602, if a negative determination is made instead then the logic may proceed to block 608. At block 608 the device may, using eye tracking software and images from an inward-facing camera imaging the user's eyes, identify a display location at which or through which the user is looking. The logic may then proceed to block 610 where the device may present content at the display location identified at block 608 so that the user is presented with the test materials but would find it difficult if not impossible to perceive real-world objects beyond the headset display in the direction of the display location for the test materials. The content that is presented at block 610 may include one or more pages of the test itself, and/or may include a warning message such as the message 408 described above. From block 610 the logic may then proceed to block 606.

At block 606 the device may, in certain circumstances if desired, also present test pages for the test in a different sequence moving forward to help further prevent cheating. From block 606 the logic may then revert back to block 600 and proceed therefrom during administration of the test or exam.

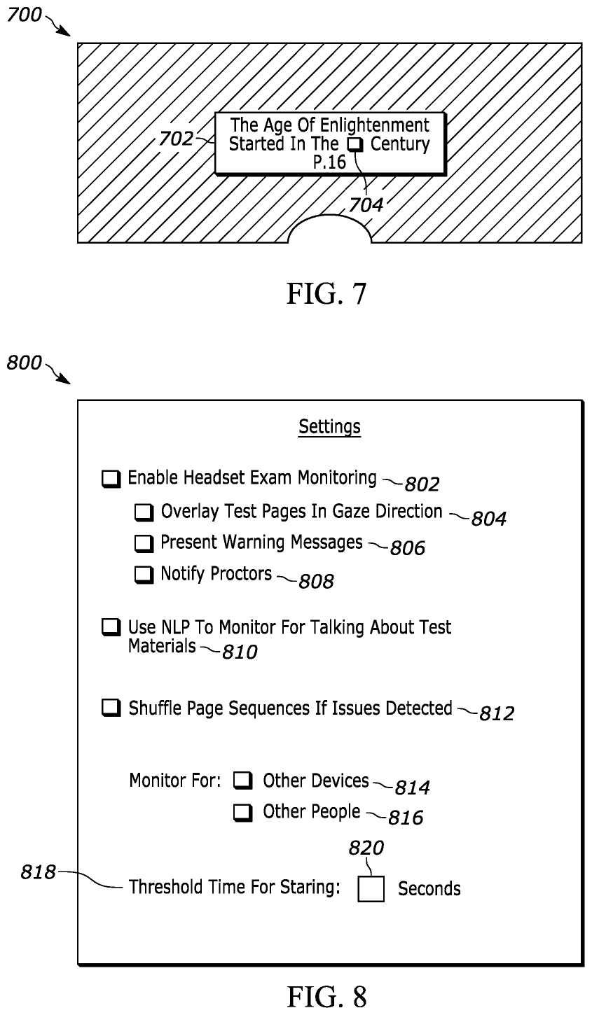

Continuing the detailed description in reference to FIG. 7, it shows another example of test page presentation at a display 700 of a headset. Here again assume that a test page 702 having a test question and answer entry box 704 is being presented at a display location at which or through which the user is looking.

To further obscure the user's view of the real world through the display 700, other portions of the display 700 that are not presenting the page 702 may present uniform black content or other possibly uniform content (represented by the shading shown), or other otherwise render other portions of the display 700 opaque by controlling the liquid crystals of the display's pixels. Thus, the page 702 may move around on the display 700 to track the direction of the user's gaze while the display 700 continues to present uniform black or other opaque content at other portions of the display 700 so that as the user looks around, the test page 702 might move according to the gaze but the user is still unable to see past the display 700 even if there is some minor latency related to presentation of the page 702 according to the current gaze direction. The example implementation shown in FIG. 7 may be presented at block 610 above, for example.

Now describing FIG. 8, it shows an example settings GUI 800 that may be presented on the display of a device for a test creator, test proctor, system administrator, or even a test-taker prior to the test-taker taking a test or exam. The settings GUI 800 may thus be used to configure one or more settings for test monitoring consistent with present principles. To this end, in the example shown each of the options or sub-options to be discussed below may be selected by directing touch or cursor input to the respective check box adjacent to the respective option/sub-option.

As shown in FIG. 8, the GUI 800 may include a first option 802 that may be selectable to set or enable the headset to, in the future, perform electronic exam monitoring consistent with present principles. For example, the option 802 may be selected to set or configure the headsets of the one or more people scheduled to take a test to execute the functions described above in reference to FIGS. 4 and 5 as well as to execute the logic of FIG. 6.

If desired, in some examples the option 802 may be accompanied by sub-options 804-808. Sub-option 804 may be selected to specifically set or configure the headsets to overlay the pages of the test on the headset displays in identified gaze directions of the test-takers as described above. Sub-option 806 may be selected to set or configure the headsets to present warning messages responsive to detecting one or more triggers as described above. Sub-option 808 may be selected to set or configure the headsets to notify the test proctor(s) responsive to detecting one or more of the triggers as described above.

As also shown in FIG. 8, the GUI 800 may include an option 810 that may be selected to specifically set or enable the headsets to use NLP to monitor for any talking/audio about subjects related to the test materials themselves as also discussed above. Additionally, the GUI 800 may include an option 812 that may be selected to specifically set or enable the headsets or associated devices providing the test pages (e.g., a managing server) to shuffle the sequence in which pages of the test are presented at a given individual headset, e.g., responsive to detecting a trigger at that headset indicative of potential cheating.

Still further, in some example implementations the GUI 800 may include an option 814 to specifically set or enable the headsets to monitor for other predetermined electronic devices that might not be permitted as described herein, as well as an option 816 to specifically set or enable the headsets to monitor for other predetermined objects such as non-test-taking people that might also be detected by the headsets.

Still further, if desired the GUI 800 may include a setting 818 at which a proctor or other person may establish the threshold time for staring as described above. For example, the threshold time may be established by directing numerical input to the input box 820 using a hard or soft keyboard in order to configure the threshold as a certain number of seconds.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

What is claimed is:

1. A headset, comprising:
at least one processor;
a display accessible to the at least one processor;
a camera accessible to the at least one processor; and
storage accessible to the at least one processor and comprising instructions executable by the at least one processor to:
receive one or more images from the camera;
based on the one or more images, identify one or more of: a predetermined object within a user's field of view, a location of the display at which or through which the user is looking; and
based on the identification, take at least one action related to administration of a test or examination.

2. The headset of claim 1, wherein the instructions are executable to:
execute eye tracking using the one or more images;
based on the eye tracking, identify the location of the display at which or through which a user is looking; and
based on the identification of the location of the display at which or through which the user is looking, present content on the display at the location to at least partially obstruct the user's view of the real world via the display.

3. The headset of claim 2, wherein the content comprises one or more of: an electronic page of the test or examination, a warning message related to cheating on the test or examination.

4. The headset of claim 1, wherein the instructions are executable to:
execute object recognition using the one or more images;
based on the object recognition, identify the predetermined object within the user's field of view; and
based on the identification, present a warning message on the display, the warning message indicating that the predetermined object should not be present during administration of the test or examination.

5. The headset of claim 4, wherein the instructions are executable to:
based on a determination that the predetermined object exists within the user's field of view for at least a threshold non-zero amount of time, transmit a notification to a device associated with a proctor, the notification indicating that the predetermined object has been identified.

6. The headset of claim 1, wherein the instructions are executable to:
execute object recognition using the one or more images;
based on the object recognition, identify the predetermined object within the user's field of view; and
based on the identification, present content on the display to at least partially obstruct the user's view of the predetermined object via the display.

7. The headset of claim 6, wherein the content comprises one or more of: an electronic page of the test or examination itself, a warning message related to cheating on the test or examination.

8. The headset of claim 6, wherein the predetermined object comprises one or more of: another electronic device besides the headset, a book, a person within a threshold distance to the headset, a person facing the headset, a person speaking, a person gesturing.

9. The headset of claim 1, wherein the instructions are executable to
execute eye tracking using the one or more images;
based on the eye tracking, identify the user as looking in a particular direction toward the location for at least a threshold non-zero amount of time; and
based on the identification of the user as looking in the particular direction for at least the threshold non-zero amount of time, one or more of: present content on the display at the location to at least partially obstruct the user's view of the real world via the display in the particular direction, present a warning message related to cheating on the test or examination.

10. The headset of claim 1, wherein the instructions are executable to:
execute object recognition using the one or more images;
based on the object recognition, identify the predetermined object within the user's field of view; and
based on the identification, transmit a notification to a device associated with a proctor, the notification indicating that the predetermined object has been identified.

11. The headset of claim 10, wherein the predetermined object comprises a non-headset electronic device being used by a person other than the user, and wherein the notification indicates the person.

12. A method, comprising:
receiving one or more images from a camera on a headset;
based on the one or more images, identifying one or more of: a predetermined object within a user's field of view, a particular location of a display of the headset, wherein the particular location is in a direction of the user's current line of sight; and
based on the identification, taking at least one action related to administration of a test or examination.

13. The method of claim 12, comprising:
executing eye tracking using the one or more images;
based on the eye tracking, identifying the particular location of the display; and
based on the identification of the particular location of the display, presenting content on the display at the particular location to at least partially obstruct the user's view of the real world via the display.

14. The method of claim 13, wherein the content comprises one or more of: an electronic page of the test or examination, a warning message related to the test or examination.

15. The method of claim 12, wherein the camera is oriented away from the headset to generate images of the user's field of view, and wherein the method comprises:
executing object recognition using the one or more images;
based on the object recognition, identifying the predetermined object within the user's field of view; and
based on the identification, presenting a warning message on the display, the warning message indicating that the predetermined object should not be present during administration of the test or examination.

16. The method of claim 15, comprising:
based on determining that the predetermined object exists within the user's field of view for at least a threshold non-zero amount of time, transmitting a notification to a device associated with a proctor, the notification indicating that the predetermined object has been identified.

17. The method of claim 15, wherein the predetermined object comprises one or more of: another electronic device besides the headset, a book, a person within a threshold distance to the headset, a person facing the headset, a person speaking, a person gesturing.

18. The method of claim 12, comprising:
executing object recognition using the one or more images;
based on the object recognition, identifying the predetermined object within the user's field of view, wherein the predetermined object comprises a non-headset electronic device being used by a person other than the user; and
based on the identification, transmitting a notification to a device associated with a proctor, the notification indicating the person.

19. At least one computer readable storage medium (CRSM) that is not a transitory signal, the computer readable storage medium comprising instructions executable by at least one processor to:
receive one or more images from a camera on a headset;
based on the one or more images, identify a predetermined object within a user's field of view and/or a particular location of a display of the headset, the particular location being in a direction of the user's current line of sight; and
based on the identification, take at least one action related to administration of a test or examination.

20. The CRSM of claim 19, wherein the at least one action comprises presenting pages of the test or examination in a first sequence that is different from a second sequence, the second sequence but not the first sequence being used prior to the identification in order to present pages of the test or examination at the headset.
